(19) United States
(12) Patent Application Publication
(10) Pub. No.: US 2015/0280197 A1
(43) Pub. Date: Oct. 1, 2015

(54) Composite Porous Separator And Electrochemical Device

(71) Applicant: Dongguan Amperex Technology Limited, Dongguan (CN)

(72) Inventors: Junhua ZHAO, Dongguan (CN); Shengwu ZHANG, Dongguan (CN); Yongle CHEN, Dongguan (CN); Hui JIANG, Dongguan (CN); Chaoyu GUAN, Dongguan (CN); Xiaoyan LI, Dongguan (CN); Wenqiang CHENG, Dongguan (CN)

(21) Appl. No.: 14/593,656

(22) Filed: Jan. 9, 2015

(30) Foreign Application Priority Data
Mar. 28, 2014 (CN) 201410126888.3

(51) Int. Cl. H01M 2/16

(52) U.S. Cl. CPC H01M 2/1686; H01M 2/1653

(57) ABSTRACT

The present disclosure provides a composite porous separator and an electrochemical device. The composite porous separator comprises: a composite porous substrate; and a composite porous coating coated on at least one surface of the composite porous substrate. The composite porous substrate comprises a filler A and a polymer matrix, the filler A is at least one selected from a group consisting of inorganic particles and organic particles; the composite porous coating comprises a filler B and an adhesive, the filler B is at least one selected from a group consisting of inorganic particles and organic particles. The electrochemical device has the above composite porous separator. The present disclosure improves the thermal stability of the composite porous separator, and improves the anti-deformation capability and the capacity retention rate of the electrochemical device, and further improves the cycle performance and the low temperature dynamic performance of the electrochemical device.

### CROSS-REFERENCE TO RELATED APPLICATIONS

The present application claims priority to Chinese patent application No. CN201410126888.3, filed on Mar. 28, 2014, which is incorporated herein by reference in its entirety.

### FIELD OF THE PRESENT DISCLOSURE

The present disclosure relates to a field of an electrochemistry technology, and more specifically to a composite porous separator and an electrochemical device.

### BACKGROUND OF THE PRESENT DISCLOSURE

A separator without a coating easily shrinks, and is fused off, oxidized, and punctured and the like, therefore there is a great risk on a safety problem of an electrochemical device.

A separator having a conventional ceramic coating is able to improve mechanical strength and fusing-off temperature of the separator, and in turn improve the safety performance of the electrochemical device using the separator. However, there are also some problems: the adhesive force between the ceramic particles and the separator is relatively low, the ceramic particles are easy to peel off during the manufacture process of the separator; that the adhesive force between the ceramic particle and the separator is relatively low cannot reduce a thickness of the ceramic coating on the premise of an assurance of the safety performancejavascript::, thereby reducing the energy density of the electrochemical device; that the ceramic coating cannot be adhered to electrode plates cannot inhibit an expansion of the electrode plates during a charge-discharge process, and in turn the electrochemical device will be deformed.

### SUMMARY OF THE PRESENT DISCLOSURE

In view of the problems existing in the background technology, an object of the present disclosure is to provide a composite porous separator and an electrochemical device, which improves the thermal stability of the composite porous separator and improves the anti-deformation capability and the capacity retention rate of the electrochemical device, and also improves the cycle performance and the low temperature dynamic performance of the electrochemical device.

In order to achieve the above object, in a first aspect of the present disclosure, the present disclosure provides a composite porous separator, which comprises: a composite porous substrate; and a composite porous coating coated on at least one surface of the composite porous substrate. The composite porous substrate comprises a filler A and a polymer matrix, the filler A is at least one selected from a group consisting of inorganic particles and organic particles; the composite porous coating comprises a filler B and an adhesive, the filler B is at least one selected from a group consisting of inorganic particles and organic particles.

In a second aspect of the present disclosure, the present disclosure provides an electrochemical device, which has the composite porous separator according to the first aspect of the present disclosure.

The present disclosure has following beneficial effects:

1. That introduction of the composite porous coating of the present disclosure greatly improves the puncture resistant strength of the composite porous separator, and at the same time reduces the thermal shrinkage ratio of the composite porous separator and improves the thermal stability of the composite porous separator.

2. The composite porous separator of the present disclosure greatly improves the adhesive performance between the electrode plates, thereby improving the anti-deformation capability of the lithium-ion secondary battery.

3. The ability to conduct lithium ions and the retention performance of the composite porous separator of the present disclosure on the electrolyte are greatly improved, so that the low temperature discharge rate and the capacity retention rate of the lithium-ion secondary battery are improved, thereby in turn improving the low temperature dynamic performance and the cycle performance of the lithium-ion secondary battery.

4. That the strong puncture resistant strength of the composite porous substrate and the strong interaction between the composite porous coating and the composite porous substrate of the present disclosure optimize the thicknesses of the composite porous substrate and the composite porous coating, thereby further improving the energy density of the lithium-ion secondary battery.

### DETAILED DESCRIPTION

Hereinafter a composite porous separator and a preparation method thereof and an electrochemical device and comparative examples, examples, and test results according to the present disclosure will be described in detail.

Firstly, a composite porous separator according to a first aspect of the present disclosure will be described.

A composite porous separator according to a first aspect of the present disclosure comprises: a composite porous substrate; and a composite porous coating coated on at least one surface of the composite porous substrate. The composite porous substrate comprises a filler A and a polymer matrix, the filler A is at least one selected from a group consisting of inorganic particles and organic particles; the composite porous coating comprises a filler B and an adhesive, the filler B is at least one selected from a group consisting of inorganic particles and organic particles. Here, a supplementary explanation is that the composite porous substrate may be provided as one, or two or more in the number of layers, the specific number of the layers may be determined based on the actual situation; the composite porous coating may be provided on the corresponding surface of the composite porous substrate based on the actual situation, preferably, the composite porous coating is coated on the surface of the composite porous substrate facing a positive electrode plate.

That the composite porous separator of the present disclosure comprises the composite porous substrate and the composite porous coating and both the composite porous substrate and the composite porous coating have granular fillers can achieve following beneficial effects: (1) improving the thermal stability and the mechanical strength of the composite porous separator, thereby improving the safety performance of the electrochemical device; (2) improving the retention performance and the infiltration performance of the composite porous separator on an electrolyte, thereby improving the ability to conduct lithium ions of the composite porous separator.

That if the composite porous separator only comprises the inorganic particle may have following beneficial effects: (1) modifying the surface chemical group of the composite porous separator, improving the adhesive force between the composite porous coating and the composite porous substrate, optimizing a thickness of the composite porous coating, thereby improving the energy density of the electrochemical device; (2) improving the electrochemical stability of the composite porous separator, thereby improving the operating voltage of the electrochemical device and greatly improving the energy density of the electrochemical device; (3) forming an excellent interface between the composite porous separator with the electrode plate during the later manufacture process, and having excellent adhesive performance between the composite porous separator and the electrode plate, allowing the electrochemical device to have an excellent mechanical performance, thereby improving the anti-deformation capability of the electrochemical device.

That if the composite porous separator only comprises the organic particle may have following beneficial effects: (1) improving the compatibility between the organic particle and the composite porous separator, so as to form a stable blend system, thereby improving the electrochemical stability of the electrochemical device; (2) introducing a group having the ability to conduct the lithium ions, improving the retention performance and the infiltration performance of the composite porous separator on the electrolyte, thereby further improving the ability to conduct the lithium ions of the composite porous separator; (3) modifying the surface chemical group of the composite porous separator, improving the adhesive force between the composite porous coating and the composite porous substrate, optimizing the thickness of the composite porous coating, thereby improving the energy density of the electrochemical device.

That if the composite porous separator comprises the organic particle and the inorganic particle can not only have the effect that the organic particle separately brings and the effect that the inorganic particle separately brings, However also may have a synergistic effect between the organic particle and the inorganic particle.

In the composite porous separator according to the first aspect of the present disclosure, the polymer matrix may be one or more selected from a group consisting of polypropylene, polyethylene, ethylene-propylene copolymer, ethylene-vinyl acetate copolymer, polyvinylidene fluoride, tetrafluoroethylene-hexafluoropropylene copolymer, polyamide and polyimide.

In the composite porous separator according to the first aspect of the present disclosure, in the composite porous substrate: a weight of the filler A may be 0.5%˜80% of a total weight of the composite porous substrate; a weight of the polymer matrix may be 20%˜99.5% of the total weight of the composite porous substrate.

In the composite porous separator according to the first aspect of the present disclosure, a thickness of the composite porous substrate may be 3 μm˜20 μm.

In the composite porous separator according to the first aspect of the present disclosure, the adhesive may be one or more selected from a group consisting of polyacrylic acid, polymethacrylic acid, polymethylacrylate, polyethylacrylate, acrylic emulsion, acrylamide emulsion, acrylic acid-styrene copolymer, polyvinylpyrrolidone, styrene butadiene rubber, epoxy resin, neopentyl glycol diacrylate, polyacrylic acid sodium salt and polytetrafluoroethylene.

In the composite porous separator according to the first aspect of the present disclosure, in the composite porous coating: a weight of the filler B may be 20%˜99.5% of the total weight of the composite porous coating; a weight of the adhesive may be 0.5%˜80% of the total weight of the composite porous coating.

In the composite porous separator according to the first aspect of the present disclosure, a thickness of the composite porous coating (that is the thickness coated on one corresponding surface of the composite porous substrate) may be 1 μm˜8 μm.

In the composite porous separator according to the first aspect of the present disclosure, a coating method of the composite porous coating may be selected from one of dip coating, gravure printing, screen printing, transfer coating, extrusion coating, spray coating, and cast coating.

In the composite porous separator according to the first aspect of the present disclosure, the inorganic particle may be one or more selected from a group consisting of inorganic salt with Rockwell hardness of more than 2 and metal oxide with Rockwell hardness of more than 2.

In the composite porous separator according to the first aspect of the present disclosure, the inorganic particle is modified by a surface modifying agent.

In the composite porous separator according to the first aspect of the present disclosure, the surface modifying agent may be one or more selected from a group consisting of coupling agent and surfactant. The coupling agent may be one or more selected from a group consisting of silane coupling agent, titanate coupling agent, zirconium coupling agent, aluminate coupling agent, borate coupling agent and phosphate coupling agent. Specifically, the coupling agent may be one or more selected from a group consisting of amino propyl triethoxy silane, aluminate, borate, phenyl trimethoxy silane, 3-(glycidoxy propyl)trimethoxy silane, 3-(trimethoxysilyl)propyl methacrylate, 3-(2-aminoethylamino)propyl dimethoxy methyl silane, titanate and polyethenoxy ether phosphate. The surfactant may be one or more selected from a group consisting of non-ionic surfactant, cation surfactant and anion surfactant. Specifically, the surfactant may be one or more selected from a group consisting of cinnamic acid, hexadecyl pyridinium bromide, hexadecyl trimethyl ammonium bromide, methyl phenyl coconut oleic acid ammonium chloride, octadecanoic acid, sorbic acid, and acrylic acid.

In the composite porous separator according to the first aspect of the present disclosure, a weight of the surface modifying agent may be 0.06%˜2% of a weight of the inorganic particles.

In the composite porous separator according to the first aspect of the present disclosure, the organic particle may be one or more selected from a group consisting of polymers having a lithium ions conductivity capacity, heat resistant polymers and flame retardant polymers. Specifically, the organic particle may be one or more selected from a group consisting of vinylidene fluoride-hexafluoropropylene copolymer, acrylonitrile-styrene-butadiene copolymer, polyacrylonitrile, polyethylacrylate, acrylic acid-styrene copolymer, acrylonitrile-butadiene copolymer, polyisophthaloyl metaphenylene diamine, polyimide, poly(p-phenylene terephtha-lamide) and polymethylacrylate.

Secondly, two preparation methods of a composite porous separator according to a second aspect of the present disclosure will be described.

A first preparation method of a composite porous separator according to a second aspect of the present disclosure comprises steps of: adding the polymer matrix, a plasticizer, an antioxidant and the filler A into a double screw extruder, performing an extruding process after mixing, stretching transversely first and then stretching longitudinally to obtain a base membrane, then immersing the stretched base membrane into an extractant and extracting the plasticizer out, then performing a thermal setting process to obtain a composite porous substrate; mixing the filler B, the adhesive and a solvent uniformly to obtain a slurry and making a solid content of the slurry achieve a predetermined value, then coating the slurry on at least one surface of the composite porous substrate uniformly to obtain a wet membrane, then drying the wet membrane via an oven to obtain a composite porous separator.

In the first preparation method of the composite porous separator according to the second aspect of the present disclosure, the plasticizer may be one or more selected from a group consisting of liquid paraffin and dioctyl phthalate; the antioxidant may be one or more selected from a group consisting of 2,6-di-tert-butylphenol, tert-butylhydroquinone, butylated hydroxytoluene, and 2,6-di-tert-butyl-4-methylphenol; the extractant may be one selected from a group consisting of dichloroethane and ethylene glycol; the solvent may be one or more selected from a group consisting of acetone, dimethyl sulfoxide, deionized water, N-methyl pyrrolidone and ethylene carbonate.

In the first preparation method of the composite porous separator according to the second aspect of the present disclosure, in the composite porous substrate, a weight of the plasticizer may be 4.7%˜38% of a total weight of the composite porous substrate; a weight of the antioxidant may be 0.1%˜0.5% of the total weight of the composite porous substrate.

In the first preparation method of the composite porous separator according to the second aspect of the present disclosure, in the composite porous substrate, the solid content of the slurry may be 7.5%˜70%.

Next a second preparation method of a composite porous separator according to a second aspect of the present disclosure will be described.

A second preparation method of the composite porous separator according to a second aspect of the present disclosure comprises steps of: adding the polymer matrix and the filler A into a double screw extruder, performing an extruding process after melting, stretching transversely first and then stretching longitudinally, then performing a thermal setting process to obtain a composite porous substrate; mixing the filler B, the adhesive and a solvent uniformly to obtain a slurry and making a solid content of the slurry achieve a predetermined value, then coating the slurry on at least one surface of the composite porous substrate uniformly to obtain a wet membrane, then drying the wet membrane via an oven to obtain a composite porous separator.

In the second preparation method of the composite porous separator according to the second aspect of the present disclosure, the solvent may be one or more selected from a group consisting of acetone, dimethyl sulfoxide, deionized water, N-methyl pyrrolidone and ethylene carbonate.

In the second preparation method of the composite porous separator according to the second aspect of the present disclosure, in the composite porous substrate, the solid content of the slurry may be 7.5%˜70%.

Hereafter an electrochemical device according to a third aspect of the present disclosure will be described.

An electrochemical device according to a third aspect of the present disclosure has the composite porous separator according to the first aspect of the present disclosure.

In the electrochemical device according to the third aspect of the present disclosure, the electrochemical device may be one selected from a group consisting of lithium secondary battery, lithium-ion secondary battery, super capacitor, fuel cell and solar battery. The lithium-ion secondary battery may be polymer lithium-ion secondary battery.

Then comparative examples and examples of composite porous separators and lithium-ion secondary batteries (act as the electrochemical devices) according to the present disclosure will be described.

### COMPARATIVE EXAMPLE 1

(1) Preparation of a Positive Electrode Plate

Active material (lithium cobaltate), conductive agent (conductive carbon), adhesive (polyvinylidene fluoride (PVDF)) according to a weight ratio of 96:2.0:2.0 were uniformly mixed with solvent (N-methyl pyrrolidone (NMP)) to form a positive electrode slurry, then the positive electrode slurry was uniformly coated on two surfaces of current collector (aluminum foil), then a drying process was performed at 85° C., which was followed by cold pressing, cutting, edge-trimming, slitting and welding a tab, and finally a positive electrode plate was obtained.

(2) Preparation of a Negative Electrode Plate

Active material (graphite), conductive agent (conductive carbon), thickening agent (sodium carboxymethyl cellulose), adhesive (styrene butadiene rubber) according to a weight ratio of 96.5:1.0:1.0:1.5 were uniformly mixed with solvent (denioned water) to form a negative electrode slurry, then the negative electrode slurry was uniformly coated on two surfaces of current collector (copper foil), then a drying process was performed at 85° C., which was followed by cold pressing, cutting, edge-trimming, slitting and welding a tab, and finally a negative electrode plate was obtained.

(3) Preparation of a Separator

The separator was polypropylene/polyethylene/polypropylene three-layered composite membrane with a thickness of 20 μm.

(4) Preparation of an Electrolyte

LiPF₆ and ethylene carbonate (EC) and diethyl carbonate (DEC) were uniformly mixed to form an electrolyte with a concentration of LiPF₆ of 1.0 mol/L (a weight ratio of EC and DEC was 3:7)

(5) Preparation of a Lithium-Ion Secondary Battery

The positive electrode plate, the separator and the negative electrode plate were wound together to form a cell, which was followed by placing the cell in an aluminum foil package bag and injecting the above electrolyte, then after processes of packing, formation, capacity testing and the like, a lithium-ion secondary battery was completed.

### COMPARATIVE EXAMPLE 2

The lithium-ion secondary battery was prepared the same as that in comparative example 1 except that in the preparation of the separator (step (3)), inorganic filler (aluminium oxide with a Rockwell hardness of 8.8) and adhesive (polyvinylidene fluoride (PVDF)) according to a weight ratio of 90:10 were uniformly mixed with solvent (deionized water) to form a slurry with a solid content of 40%, then the slurry was uniformly coated on one surface of the polymer substrate (polyethylene with a thickness of 20 μm) via a micro-gravure printing to obtain a wet membrane, then the wet membrane was dried via an oven to obtain a composite porous separator, a thickness of the dried coating was 10 μm.

### EXAMPLE 1

The lithium-ion secondary battery was prepared the same as that in comparative example 1 except that in the preparation of the separator (step (3)),

54 wt % polymer matrix (polyvinylidene fluoride), 14.5 wt % plasticizer (liquid paraffin), 0.5 wt % antioxidant (2,6-di-tert-butylphenol) and 31 wt % filler A (titanium lithium carbonate with a Rockwell hardness of 3.6 (titanium lithium carbonate was surface modified by surface modifying agent (amino propyl triethoxy silane), a weight of the surface modifying agent was 0.1% of a weight of titanium lithium carbonate) were mixed and extruded via a double screw extruder, then stretching transversely first and then stretching longitudinally were performed to obtain a base membrane, then the base membrane obtained after stretching was immersed into extractant (dichloroethane) to extract plasticizer (liquid paraffin) out, then a thermal setting process was performed to obtain a composite porous substrate with a thickness of 14 μm; 98 wt % of filler B (a mixture of aluminium oxide with a Rockwell hardness of 8.8 (aluminium oxide was surface modified by surface modifying agent (phenyl trimethoxy silane), a weight of the surface modifying agent was 1.0% of a weight of the aluminium oxide) and vinylidene fluoride-hexafluoropropylene copolymer according to a weight ratio of 2:1) and 2 wt % adhesive (polymethylacrylate) were uniformly mixed with solvent (deionized water) to form a slurry with a solid content of 50%, then the slurry was uniformly coated on two surfaces of the composite porous substrate via a micro-gravure printing to obtain a wet membrane, then the wet membrane was dried via an oven to obtain a composite porous separator, the slurry became the composite porous coating after drying, and a thickness of each composite porous coating was 3 μm.

### EXAMPLE 2

The lithium-ion secondary battery was prepared the same as that in comparative example 1 except that in the preparation of the separator (step (3)),

20 wt % polymer matrix (polypropylene) and 80 wt % filler A (a mixture of calcium sulfate with a Rockwell hardness of 3.6 (calcium sulfate was surface modified by surface modifying agent (cinnamic acid), a weight of the surface modifying agent was 0.15% of a weight of the calcium sulfate) and polyimide according to a weight ratio of 1:1) were mixed and processed a melt extrusion via a double screw extruder, then stretching transversely first and then stretching longitudinally were performed, then a thermal setting process was performed to obtain a composite porous substrate with a thickness of 20 μm;

20 wt % filler B (acrylonitrile-styrene-butadiene copolymer) and 80 wt % adhesive (acrylic acid-styrene copolymer) were uniformly mixed with solvent (acetone) to form a slurry with a solid content of 55%, then the slurry was uniformly coated on two surfaces of the composite porous substrate via a screen printing to obtain a wet membrane, then the wet membrane was dried via an oven to obtain a composite porous separator, the slurry became the composite porous coating after drying, and a thickness of each composite porous coating was 1 μm.

### EXAMPLE 3

The lithium-ion secondary battery was prepared the same as that in comparative example 1 except that in the preparation of the separator (step (3)),

99.5 wt % polymer matrix (polypropylene) and 0.5 wt % filler A (poly(p-phenylene terephthalamide)) were uniformly mixed and processed a melt extrusion via a double screw extruder, then stretching transversely first and then stretching longitudinally were performed, then a thermal setting process was performed to obtain a composite porous substrate with a thickness of 11 μm;

76 wt % filler B (a mixture of silicon dioxide with a Rockwell hardness of 6.1 (silicon dioxide was surface modified by surface modifying agent (3-glycidoxy propyl trimethoxysilane), a weight of surface modifying agent was 2.0% of a weight of silicon dioxide) and polyacrylonitrile according to a weight ratio of 1:3) and 24 wt % adhesive (acrylamide emulsion) were uniformly mixed with solvent (deionized water) to form a slurry with a solid content of 70%, then the slurry was uniformly coated on two surfaces of the composite porous substrate via an extrusion coating to obtain a wet membrane, then the wet membrane was dried via an oven to obtain a composite porous separator, the slurry became the composite porous coating after drying, and a thickness of each composite porous coating was 3 μm.

### EXAMPLE 4

The lithium-ion secondary battery was prepared the same as that in comparative example 1 except that in the preparation of the separator (step (3)),

68 wt % polymer matrix (polyamide), 19.9 wt % plasticizer (dioctyl phthalate), 0.1 wt % antioxidant (2,6-di-tert-butylphenol) and l2 wt % filler A (titanium aluminum lithium carbonate with a Rockwell hardness of 3.7 (titanium aluminum lithium carbonate was surface modified by surface modifying agent (3-(trimethoxysilyl)propyl methacrylate), a weight of the surface modifying agent was 0.3% of a weight of titanium aluminum lithium carbonate)) were mixed and extruded via a double screw extruder, then stretching transversely first and then stretching longitudinally were performed to obtain a base membrane, then the base membrane obtained after stretching was immersed into extractant (ethylene glycol) to extract plasticizer (dioctyl phthalate) out, then a thermal setting process was performed to obtain a composite porous substrate with a thickness of 3 μm;

82 wt % filler B (a mixture of magnesium sulphate with a Rockwell hardness of 2.7 (magnesium sulphate was surface modified by surface modifying agent (acrylic acid), a weight of the surface modifying agent was 0.3% of a weight of magnesium sulphate) and polyethylacrylate according to a weight ratio of 3:1) and 18 wt % adhesive (epoxy resin) were uniformly mixed with solvent (ethylene carbonate) to form a slurry with a solid content of 70%, then the slurry was uniformly coated on one surface of the composite porous substrate via a transfer coating to obtain a wet membrane, then the wet membrane was dried via an oven to obtain a composite porous separator, the slurry became the composite porous coating after drying, and a thickness of the composite porous coating was 6 μm.

### EXAMPLE 5

The lithium-ion secondary battery was prepared the same as that in comparative example 1 except that in the preparation of the separator (step (3)),

29 wt % polymer matrix (polyethylene), 24.8 wt % plasticizer (liquid paraffin), 0.2 wt % antioxidant (tert-butylhydroquinone), and 46 wt % filler A (aluminum carbonate with a Rockwell hardness of 4.1 (aluminum carbonate was surface modified by surface modifying agent (methyl phenyl coconut oleic acid ammonium chloride), a weight of the surface modifying agent was 0.5% of a weight of aluminum carbonate)) were mixed and extruded via a double screw extruder, then stretching transversely first and then stretching longitudinally were performed to obtain a base membrane, then the base membrane obtained after stretching was immersed into extractant (dichloroethane) to extract plasticizer (liquid paraffin) out, then a thermal setting process was performed to obtain a composite porous substrate with a thickness of 10 μm;

99.5 wt % filler B (acrylic acid-styrene copolymer) and 0.5 wt % adhesive (styrene butadiene rubber) were uniformly mixed with solvent (deionized water) to form a slurry with a solid content of 25%, then the slurry was uniformly coated on two surfaces of the composite porous substrate via a dip coating to obtain a wet membrane, then the wet membrane was dried via an oven to obtain a composite porous separator, the slurry became the composite porous coating after drying, and a thickness of each composite porous coating was 2 μm.

### EXAMPLE 6

The lithium-ion secondary battery was prepared the same as that in comparative example 1 except that in the preparation of the separator (step (3)),

69 wt % polymer matrix (ethylene-propylene copolymer), 29.3 wt % plasticizer (liquid paraffin), 0.3 wt % antioxidant (tert-butylhydroquinone) and lwt % filler A (polyethyl acrylate) were mixed and extruded via a double screw extruder, then stretching transversely first and then stretching longitudinally were performed to obtain a base membrane, then the base membrane obtained after stretching was immersed into extractant (dichloroethane) to extract plasticizer (liquid paraffin) out, then a thermal setting process was performed to obtain a composite porous substrate with a thickness of 4 μm;

99 wt % filler B (acrylonitrile-butadiene copolymer) and 1 wt % adhesive (polymethacrylic acid) were uniformly mixed with solvent (deionized water) to form a slurry with a solid content of 15%, then the slurry was uniformly coated on one surface of the composite porous substrate via a dip coating to obtain a wet membrane, then the wet membrane was dried via an oven to obtain a composite porous separator, the slurry became the composite porous coating after drying, and a thickness of the composite porous coating was 8 μm.

### EXAMPLE 7

The lithium-ion secondary battery was prepared the same as that in comparative example 1 except that in the preparation of the separator (step (3)),

63 wt % polymer matrix (ethylene-vinyl acetate copolymer), 34.1 wt % plasticizer (liquid paraffin), 0.4 wt % antioxidant (tert-butylhydroquinoneand) and 2 wt % filler A (a mixture of titanium dioxide with a Rockwell hardness of 6.1 (titanium dioxide was surface modified by surface modifying agent (hexadecyl pyridinium bromide), a weight of the surface modifying agent was 0.06% of a weight of titanium dioxide) and polymethylacrylate according to a weight ratio of 1:5) were mixed and extruded via a double screw extruder, then stretching transversely first and then stretching longitudinally were performed to obtain a base membrane, then the base membrane obtained after stretching was immersed into extractant (dichloroethane) to extract plasticizer (liquid paraffin) out, then a thermal setting process was performed to obtain a composite porous substrate with a thickness of 6 μm;

98.5 wt % filler B (a mixture of barium titanate with a Rockwell hardness 5.4 (barium titanate was surface modified by surface modifying agent (3-(2-aminoethylamino)propyl-dimethoxymethylsilane), a weight of the surface modifying agent was 0.07% of a weight of barium titanate) and acrylonitrile-styrene-butadiene copolymer according to a weight ratio of 5:1) and 1.5 wt % adhesive (polytetrafluoroethylene) were uniformly mixed with solvent (N-methyl pyrrolidone) to form a slurry with a solid content of 10%, then the slurry was uniformly coated on one surface of the composite porous substrate via a dip coating to obtain a wet membrane, then the wet membrane was dried via an oven to obtain a composite porous separator, the slurry became the composite porous coating after drying, and a thickness of the composite porous coating was 5 μm.

### EXAMPLE 8

The lithium-ion secondary battery was prepared the same as that in comparative example 1 except that in the preparation of the separator (step (3)),

85 wt % polymer matrix (polyvinylidene fluoride), 9 wt % plasticizer (liquid paraffin), 0.5 wt % antioxidant (butylated hydroxytoluene) and 5 wt % filler A (a mixture of strontium sulfate with a Rockwell hardness of 3.0 (strontium sulfate was surface modified by surface modifying agent (aluminate), a weight of the surface modifying agent was 0.07% of a weight of strontium sulfate) and polyisophthaloyl metaphenylene diamine according to a weight ratio of 2:5) were mixed and extruded via a double screw extruder, then stretching transversely first and then stretching longitudinally were performed to obtain a base membrane, then the base membrane obtained after stretching was immersed into extractant (dichloroethane) to extract plasticizer (liquid paraffin) out, then a thermal setting process was performed to obtain a composite porous substrate with a thickness of 12 μm;

96.5 wt % filler B (a mixture of magnesium oxide with a Rockwell hardness of 5.8 (magnesium oxide was surface modified by surface modifying agent (a mixture of sorbic acid and titanate according to a weight ratio of 1:2), a weight of the surface modifying agent was 0.08% of a weight of magnesium oxide) and acrylic acid-styrene copolymer according to a weight ratio of 5:2) and 3.5 wt % adhesive (a mixture of acrylic emulsion and styrene butadiene rubber according to a weight ratio of 1:2) were uniformly mixed with solvent (deionized water) to form a slurry with a solid content of 7.5%, then the slurry was uniformly coated on one surface of the composite porous substrate via a dip coating to obtain a wet membrane, then the wet membrane was dried via an oven to obtain a composite porous separator, the slurry became the composite porous coating after drying, and a thickness of the composite porous coating was 4 μm.

### EXAMPLE 9

The lithium-ion secondary battery was prepared the same as that in comparative example 1 except that in the preparation of the separator (step (3)),

88 wt % polymer matrix (hexafluoropropene-tetrafluoroethylene copolymer), 4.7 wt % plasticizer (liquid paraffin), 0.3 wt % antioxidant (butylated hydroxytoluene) and 7 wt % filler A (a mixture of titanium lithium carbonate with a Rockwell hardness of 4.3 (titanium lithium carbonate was surface modified by surface modifying agent (hexadecyl trimethyl ammonium bromide), a weight of the surface modifying agent was 0.1% of titanium lithium carbonate) and polyacrylonitrile according to a weight ratio of 2:3) were uniformly mixed and extruded via a double screw extruder, then stretching transversely first and then stretching longitudinally were performed to obtain a base membrane, then the base membrane obtained after stretching was immersed into extractant (dichloroethane) to extract plasticizer (liquid paraffin) out, then a thermal setting process was performed to obtain a composite porous substrate with a thickness of 5 μm;

94.5 wt % filler B (a mixture of cerium oxide with a Rockwell hardness of 6.2 (cerium oxide was surface modified by surface modifying agent (polyethenoxy ether phosphate), a weight of the surface modifying agent was 0.3% a weight of cerium oxide) and polyisophthaloyl metaphenylene diamine according to a weight ratio of 3:2) and 5.5 wt % adhesive (epoxy resin) were uniformly mixed with solvent (deionized water) to form a slurry with a solid content of 7.5%, then the slurry was uniformly coated on two surfaces of the composite porous substrate via a spray coating to obtain a wet membrane, then the wet membrane was dried via an oven to obtain a composite porous separator, the slurry became the composite porous coating after drying, and a thickness of each composite porous coating was 4 μm.

### EXAMPLE 10

The lithium-ion secondary battery was prepared the same as that in comparative example 1 except that in the preparation of the separator (step (3)),

55 wt % polymer matrix (a mixture of polypropylene and polyethylene according to a weight ratio of 1:8), 38 wt % plasticizer (liquid paraffin), 0.3 wt % antioxidant (2,6-di-tert-butyl-4-methylphenol) and 5 wt % filler A (a mixture of aluminium sulfate with a Rockwell hardness of 3.1 (aluminium sulfate was surface modified by surface modifying agent (borate), a weight of the surface modifying agent was 0.7% a weight of aluminium sulfate) and polyisophthaloyl metaphenylene diamine and polyacrylonitrile according to a weight ratio of 1:3:7) were uniformly mixed and extruded via a double screw extruder, then stretching transversely first and then stretching longitudinally were performed to obtain a base membrane, then the base membrane obtained after stretching was immersed into extractant (dichloroethane) to extract plasticizer (liquid paraffin) out, then a thermal setting process was performed to obtain a composite porous substrate with a thickness of 11 μm;

60 wt % filler B (a mixture of lithium phosphate with a Rockwell hardness of 4.2 (lithium phosphate was surface modified by surface modifying agent (octadecanoic acid), a weight of surface modifying agent was 0.08% of a weight of lithium phosphate) and calcium oxide with a Rockwell hardness of 2.6 (calcium oxide was surface modified by surface modifying agent (a mixture of titanate and octadecanoic acid according to a weight ratio of 2:3), a weight of the surface modifying agent was 0.4% of a weight of calcium oxide) and polyimide according to a weight ratio of 2:3:2) and 40 wt % adhesive (a mixture of acrylamide emulsion and styrene butadiene rubber according to a weight ratio of 3:2) were uniformly mixed with solvent (deionized water) to form a slurry with a solid content of 7.5%, then the slurry was uniformly coated on one surface of the composite porous substrate via a cast coating to obtain a wet membrane, then the wet membrane was dried via an oven to obtain a composite porous separator, the slurry became the composite porous coating after drying, and a thickness of the composite porous coating was 3 μm.

Finally testing processes and test results of composite porous separators and electrochemical devices of comparative examples 1-2 and examples 1-10 would be described.

(1) Testing of the puncture resistant strength of the separators: the separator was punctured at a speed of 50mm/min via a wire nail with a diameter of 0.5mm.

(2) Testing of the thermal shrinkage ratio of the separators: the separator was stamped into a rectangle sample via a cutting die, then the separator was put into an oven at a special and constant temperature, then the separator was taken out after a certain period of time, finally the shrinkage ratio of the separator before and after the thermal process was measured.

(3) Testing of the low temperature discharge rate of the lithium-ion secondary batteries: the lithium-ion secondary battery was charged at a constant current of 0.5 C at 0° C., then the lithium-ion secondary battery was discharged at a constant current of 2 C at 0° C. The capacity retention rate of the lithium-ion secondary battery after a low temperature charge-discharge cycle was calculated as follows: the capacity retention rate=(the capacity of the lithium-ion secondary battery after the charge-discharge cycle at 0° C./the capacity of the lithium-ion secondary battery before the charge-discharge cycle at room temperature)x 100%.

(4) Testing of the room temperature cycle performance of the lithium-ion secondary batteries: the lithium-ion secondary battery was charged at a constant current of 0.5 C at room temperature, then the lithium-ion secondary battery was discharged at a constant current of 0.5 C at room temperature, the above process was a charge-discharge cycle, then the charge-discharge cycle was repeated for 500 times. The capacity retention rate after 500 cycles was calculated as follows: the capacity retention rate=(the capacity of the lithium-ion secondary battery after 500 cycles/the capacity of the lithium-ion secondary battery before the charge-discharge cycle at room temperature)×100%.

(5) Testing of the high temperature storage performance of the lithium-ion secondary batteries: the lithium-ion secondary battery was charged to full charge (4.2V) and storaged for 30 days at 80° C. The thickness expansion rate was calculated as follows: the thickness expansion rate=(the thickness variation of the lithium-ion secondary battery before and after storage/the thickness of the lithium-ion secondary battery before storage)x 100%.

Table 1 illustrated parameters of comparative examples 1-2 and examples 1-10.

Table 2 illustrated test results of the separators and the lithium-ion secondary batteries of comparative examples 1-2 and examples 1-10.

It could be seen from the test results of Table 2, the puncture resistant strengths of the composite porous separators of examples 1-10 of the present disclosure were greatly increased compared to those of comparative examples 1-2, at the same time the thermal shrinkage rate of the composite porous separators of the present disclosure were greatly decreased, thereby in turn improving the thermal stability of the composite porous separators of the present disclosure.

The adhesive performances between the electrode plates of examples 1-10 were greatly improved compared to those of comparative examples 1-2, this was because the lithium-ion secondary batteries of examples 1-10 used the composite porous separator, thereby improving the anti-deformation capability of the lithium-ion secondary battery. Furthermore, the ability to conduct lithium ions and the retention performance of the composite porous separator on the electrolyte were greatly improved, thereby further improving the low temperature discharge rate and the capacity retention rate of the lithium-ion secondary battery and also decreasing the thickness expansion rate of the lithium-ion secondary battery, thereby finally improving the cycle performance and the low temperature dynamic performance of the lithium-ion secondary battery.

Moreover, it could be seen from a comparison among examples 1-10, the performance of the separator of example 8 was the best, this was because the composite porous substrate of example 8 was relatively thicker and the ratio of filler A and fill B was moderate, and at the same time the composite porous coating containing the inorganic particle with a higher hardness and a higher weight fraction, thereby making the composite porous coating have a highest puncture resistant strength.

TABLE 1
Parameters of comparative examples 1-2 and examples 1-10

| | composite porous substrate | | | | | |
|---|---|---|---|---|---|---|
| | polymer matrix | | plasticizer | | antioxidant | |
| | content/% | name | content/% | name | content/% | name |
| Comparative | / | polypropylene/ | / | / | / | / |
| example 1 | | polyethylene/ | | | | |
| | | polypropylene | | | | |
| Comparative | / | polyethylene | / | / | / | / |
| example 2 | | | | | | |
| Example 1 | 54.0 | polyvinylidene | 14.5 | liquid paraffin | 0.5 | 2,6-di-tert- |
| | | fluoride | | paraffin | | butylphenol |
| Example 2 | 20.0 | polypropylene | / | / | / | / |
| Example 3 | 99.5 | polypropylene | / | / | / | / |
| Example 4 | 68.0 | polyamide | 19.9 | dioctyl | 0.1 | 2,6-di-tert- |
| | | | | phthalate | | butylphenol |
| Example 5 | 29.0 | polyethylene | 24.8 | liquid paraffin | 0.2 | tert- |
| | | | | paraffin | | butylhydroquinone |
| Example 6 | 69.0 | ethylene- | 29.3 | liquid paraffin | 0.3 | tert- |
| | | propylene | | paraffin | | butylhydroquinone |
| | | copolymer | | | | |
| Example 7 | 63.0 | ethylene-vinyl | 34.1 | liquid paraffin | 0.4 | tert- |
| | | acetate copolymer | | paraffin | | butylhydroquinone |
| Example 8 | 85.0 | polyvinylidene | 9.0 | liquid paraffin | 0.5 | butylated |
| | | fluoride | | paraffin | | hydroxytoluene |
| Example 9 | 88.0 | hexafluoropropene - | 4.7 | liquid paraffin | 0.3 | butylated |
| | | tetrafluoroethylene | | paraffin | | hydroxytoluene |
| Example 10 | 55.0 | polypropylene:polyethylene = | 38.0 | liquid paraffin | 0.3 | 2,6-di-tert-butyl-4- |
| | | 1:8 | | paraffin | | methylphenol |

| | composite porous substrate | | | | | | | |
|---|---|---|---|---|---|---|---|---|
| | filter A | | | | | | | |
| | | | | | | | inorganic | |
| | total | | | | | | particle/ | |
| | content/ | Rockwell | inorganic | surface modifying agent | | | organic | thick- |
| | % | hardness | particle | and content/% | | organic particle | particle | ness/μm |
| Comparative | / | / | / | / | / | / | / | 20 |
| example 1 | | | | | | | | |
| Comparative | / | / | / | / | / | / | / | 20 |
| example 2 | | | | | | | | |
| Example 1 | 31.0 | 3.6 | titanium | 0.1 | amino propyl | / | / | 14 |
| | | | lithium | | triethoxy silane | | | |
| | | | carbonate | | | | | |
| Example 2 | 80.0 | 3.6 | calcium | 0.15 | cinnamic acid | polyimide | 1:1 | 20 |
| | | | sulfate | | | | | |
| Example 3 | 0.5 | / | / | / | / | poly(p-phenylene | / | 11 |
| | | | | | | terephthamide) | | |
| Example 4 | 12.0 | 3.7 | titanium | 0.3 | 3-(trimethoxysilyl) | / | / | 3 |
| | | | aluminum | | propyl | | | |
| | | | lithium | | methacrylate | | | |
| | | | carbonate | | | | | |
| Example 5 | 46.0 | 4.1 | aluminum | 0.5 | methyl phenyl | / | / | 10 |
| | | | carbonate | | coconut oleic acid | | | |
| | | | | | ammonium | | | |
| | | | | | chloride | | | |
| Example 6 | 1.0 | / | / | / | / | polyethylacrylate | / | 4 |
| Example 7 | 2.0 | 6.1 | titanium | 0.06 | hexadecyl | polymethylacrylate | 1:5 | 6 |
| | | | dioxide | | pyridinium | | | |
| | | | | | bromide | | | |
| Example 8 | 5.0 | 3.0 | strontium | 0.07 | aluminate | polyisophthaloyl | 2:5 | 12 |
| | | | sulfate | | | metaphenylene | | |
| | | | | | | diamine | | |
| Example 9 | 7.0 | 4.3 | titanium | 0.1 | hexadecyl | polyacrylonitrile | 2:3 | 5 |
| | | | lithium | | trimethyl | | | |
| | | | carbonate | | ammonium | | | |
| | | | | | bromide | | | |
| Example 10 | 5.0 | 3.1 | aluminium | 0.7 | borate | polyisophthaloyl | 1:(3:7) | 11 |
| | | | sulfate | | | metaphenylene | | |
| | | | | | | diamine/ | | |
| | | | | | | polyacrylonitrile | | |

| | composite porous coating | | | | | |
|---|---|---|---|---|---|---|
| | filler B | | | | | |
| | total content/ | Rockwell | inorganic | surface modifying agent and | | |
| | % | hardness | particle | content/% | | organic particle |
| Comparative | / | / | / | / | / | / |
| example 1 | | | | | | |
| Comparative | 90.0 | 8.8 | aluminium | / | / | / |
| example 2 | | | oxide | | | |
| Example 1 | 98.0 | 8.8 | aluminium | 1.0 | phenyl trimethoxy silane | vinylidene fluoride- |
| | | | oxide | | | hexafluoropropylene |
| | | | | | | copolymer |
| Example 2 | 20.0 | / | / | / | / | acrylonitrile-styrene- |
| | | | | | | butadiene copolymer |
| Example 3 | 76.0 | 6.1 | silicon dioxide | 2.0 | 3-glycidoxy propyl | polyacrylonitrile |
| | | | | | trimethoxysilane | |
| Example 4 | 82.0 | 2.7 | magnesium | 0.3 | acrylic acid | polyethylacrylate |
| | | | sulphate | | | |
| Example 5 | 99.5 | / | / | / | / | acrylic acid-styrene |
| | | | | | | copolymer |
| Example 6 | 99.0 | / | / | / | / | acrylonitrile-butadiene |
| | | | | | | copolymer |
| Example 7 | 98.5 | 5.4 | barium titanate | 0.07 | 3-(2- | acrylonitrile-styrene- |
| | | | | | aminoethylamino)propyl- | butadiene copolymer |
| | | | | | dimethoxymethylsilane | |
| Example 8 | 96.5 | 5.8 | magnesium | 0.08 | sorbic acid:titanate = 1:2 | acrylic acid-styrene |
| | | | oxide | | | copolymer |
| Example 9 | 94.5 | 6.2 | cerium oxide | 0.3 | polyethenoxy ether | polyisophthaloyl |
| | | | | | phosphate | metaphenylene |
| | | | | | | diamine |
| Example 10 | 60.0 | 4.2/2.6 | lithium | 0.08/0.4 | octadecanoic acid/ | polyimide |
| | | | orthophosphate/ | | (titanate:octadecanoic | |
| | | | calcium oxide | | acid = 2:3) | |

| | composite porous coating | | | | | | |
|---|---|---|---|---|---|---|---|
| | filter B | | | | | | |
| | inorganic | | | | | | thickness |
| | particle/ | | | | | | after |
| | organic | adhesive | | | solid content/ | coating | drying/ |
| | particle | content/% | name | solvent | % | method | μm |
| Comparative | / | / | / | / | / | / | / |
| example 1 | | | | | | | |
| Comparative | / | 10.0 | polyvinylidene | deionized | 40.0 | micro- | 10 |
| example 2 | | | fluoride | water | | gravure | |
| | | | | | | printing | |
| Example 1 | 2:1 | 2.0 | polymethylacrylate | deionized | 50.0 | micro- | 3 + 3 |
| | | | | water | | gravure | |
| | | | | | | printing | |
| Example 2 | / | 80.0 | acrylic acid-styrene | acetone | 55.0 | screen | 1 + 1 |
| | | | copolymer | | | printing | |
| Example 3 | 1:3 | 24.0 | acrylamide emulsion | deionized | 70.0 | extrusion | 3 + 3 |
| | | | | water | | coating | |
| Example 4 | 3:1 | 18.0 | epoxy resin | ethylene | 70.0 | transfer | 6 |
| | | | | carbonate | | coating | |
| Example 5 | / | 0.5 | styrene butadiene | deionized | 25.0 | dip | 2 + 2 |
| | | | rubber | water | | coating | |
| Example 6 | / | 1.0 | polymethacrylic acid | deionized | 15.0 | dip | 8 |
| | | | | water | | coating | |
| Example 7 | 5:1 | 1.5 | polytetrafluoroethylene | N-methyl | 10.0 | dip | 5 |
| | | | | pyrrolidone | | coating | |
| Example 8 | 5:2 | 3.5 | acrylic emulsion:styrene | deionized | 7.5 | dip | 4 |
| | | | butadiene | water | | coating | |
| | | | rubber = 1:2 | | | | |
| Example 9 | 3:2 | 5.5 | epoxy resin | deionized | 10.0 | dip | 4 + 4 |
| | | | | water | | coating | |
| Example 10 | (2:3):2 | 40.0 | acrylamide | deionized | 23.0 | dip | 3 |
| | | | emulsion:styrene | water | | coating | |
| | | | butadiene rubber = 3:2 | | | | |

TABLE 2
Test results of comparative examples 1-2 and examples 1-10

| | separator | | lithium-ion secondary battery | | |
|---|---|---|---|---|---|
| | puncture | thermal | capacity retention | capacity retention | thickness |
| | resistant | shrinkage | rate at low | rate at room temp. | expansion |
| | strength/Kgf | ratio/% | temperature/% | after 500 cycles/% | rate/% |
| Comparative | 0.241 | 2.1 | 85.0 | 82.1 | 21.1 |
| example 1 | | | | | |
| Comparative | 0.310 | 1.1 | 88.0 | 85.0 | 16.0 |
| example 2 | | | | | |
| Example 1 | 0.538 | 0.1 | 91.0 | 92.0 | 4.5 |
| Example 2 | 0.446 | 0.2 | 92.0 | 93.0 | 3.1 |
| Example 3 | 0.392 | 0.3 | 90.0 | 92.0 | 3.8 |
| Example 4 | 0.388 | 0.3 | 90.0 | 92.0 | 3.5 |
| Example 5 | 0.553 | 0.1 | 92.0 | 93.0 | 3.7 |
| Example 6 | 0.397 | 0.2 | 90.0 | 92.0 | 3.6 |
| Example 7 | 0.409 | 0.2 | 90.0 | 92.0 | 4.6 |
| Example 8 | 0.579 | 0.1 | 91.0 | 93.0 | 4.6 |
| Example 9 | 0.425 | 0.2 | 91.0 | 92.0 | 4.4 |
| Example 10 | 0.549 | 0.1 | 92.0 | 92.0 | 3.2 |

What is claimed is:

1. A composite porous separator, comprising:
a composite porous substrate; and
a composite porous coating coated on at least one surface of the composite porous substrate;
the composite porous substrate comprising a filler A and a polymer matrix, the filler A being at least one selected from a group consisting of inorganic particles and organic particles; and
the composite porous coating comprising a filler B and an adhesive, the filler B being at least one selected from a group consisting of inorganic particles and organic particles.

2. The composite porous separator according to claim 1, wherein the polymer matrix is one or more selected from a group consisting of polypropylene, polyethylene, ethylene-propylene copolymer, ethylene-vinyl acetate copolymer, polyvinylidene fluoride, tetrafluoroethylene-hexafluoropropylene copolymer, polyamide and polyimide.

3. The composite porous separator according to claim 1, wherein in the composite porous substrate:
a weight of the filler A is 0.5%˜80% of a total weight of the composite porous substrate; and
a weight of the polymer matrix is 20%˜99.5% of the total weight of the composite porous substrate.

4. The composite porous separator according to claim 1, wherein
a thickness of the composite porous substrate is 3 μm˜20 μm; and
a thickness of the composite porous coating is 1 μm˜8 μm.

5. The composite porous separator according to claim 1, wherein the adhesive is one or more selected from a group consisting of polyacrylic acid, polymethacrylic acid, polymethylacrylate, polyethylacrylate, acrylic emulsion, acrylamide emulsion, acrylic acid-styrene copolymer, polyvinylpyrrolidone, styrene butadiene rubber, epoxy resin, neopentyl glycol diacrylate, polyacrylic acid sodium salt and polytetrafluoroethylene.

6. The composite porous separator according to claim 1, wherein in the composite porous coating:
a weight of the filler B is 20%˜99.5% of a total weight of the composite porous coating; and
a weight of the adhesive is 0.5%˜80% of the total weight of the composite porous coating.

7. The composite porous separator according to claim 1, wherein the inorganic particle is one or more selected from a group consisting of inorganic salt with Rockwell hardness of more than 2 and metal oxide with Rockwell hardness of more than 2.

8. The composite porous separator according to claim 1, wherein the inorganic particle is modified by a surface modifying agent.

9. The composite porous separator according to claim 1, wherein the organic particle is one or more selected from a group consisting of polymers having a lithium ions conductivity capacity, heat resistant polymers and flame resistant polymers.

10. An electrochemical device, having a composite porous separator, the composite porous separator comprising:
a composite porous substrate; and
a composite porous coating coated on at least one surface of the composite porous substrate;
the composite porous substrate comprising a filler A and a polymer matrix, the filler A being at least one selected from a group consisting of inorganic particles and organic particles; and
the composite porous coating comprising a filler B and an adhesive, the filler B being at least one selected from a group consisting of inorganic particles and organic particles.

11. The electrochemical device according to claim 10, wherein the polymer matrix is one or more selected from a group consisting of polypropylene, polyethylene, ethylene-propylene copolymer, ethylene-vinyl acetate copolymer, polyvinylidene fluoride, tetrafluoroethylene-hexafluoropropylene copolymer, polyamide and polyimide.

12. The electrochemical device according to claim 10, wherein in the composite porous substrate:
a weight of the filler A is 0.5%˜80% of a total weight of the composite porous substrate; and
a weight of the polymer matrix is 20%˜99.5% of the total weight of the composite porous substrate.

13. The electrochemical device according to claim 10, wherein
a thickness of the composite porous substrate is 3 μm˜20 μm; and
a thickness of the composite porous coating is 1 μm˜8 μm.

14. The electrochemical device according to claim 10, wherein the adhesive is one or more selected from a group consisting of polyacrylic acid, polymethacrylic acid, polymethylacrylate, polyethylacrylate, acrylic emulsion, acrylamide emulsion, acrylic acid-styrene copolymer, polyvinylpyrrolidone, styrene butadiene rubber, epoxy resin, neopentyl glycol diacrylate, polyacrylic acid sodium salt and polytetrafluoroethylene.

15. The electrochemical device according to claim 10, wherein in the composite porous coating:
a weight of the filler B is 20%˜99.5% of a total weight of the composite porous coating; and
a weight of the adhesive is 0.5%˜80% of the total weight of the composite porous coating.

16. The electrochemical device according to claim 10, wherein the inorganic particle is one or more selected from a group consisting of inorganic salt with Rockwell hardness of more than 2 and metal oxide with Rockwell hardness of more than 2.

17. The electrochemical device according to claim 10, wherein the inorganic particle is modified by a surface modifying agent.

18. The electrochemical device according to claim 10, wherein the organic particle is one or more selected from a group consisting of polymers having a lithium ions conductivity capacity, heat resistant polymers and flame resistant polymers.
